(19) United States
(12) Patent Application Publication
(10) Pub. No.: US 2023/0418019 A1
(43) Pub. Date: Dec. 28, 2023

(54) Electronic Device With Lens Position Sensing

(71) Applicant: Apple Inc., Cupertino, CA (US)

(72) Inventors: Timo Birnschein, Redwood City, CA (US); Nicholas C Soldner, Los Altos, CA (US); Matin Seadat Beheshti, Sunnyvale, CA (US); Bijeta Chakraborty, San Jose, CA (US); Joryl P Calizo, San Jose, CA (US); Shannon Pomeroy, San Francisco, CA (US); Amin Farzaneh, Los Angeles, CA (US)

(21) Appl. No.: 18/336,703

(22) Filed: Jun. 16, 2023

Related U.S. Application Data
(60) Provisional application No. 63/355,990, filed on Jun. 27, 2022.
(60) Provisional application No. 63/431,514, filed on Dec. 9, 2022.

(51) Int. Cl. G02B 7/02; G01L 1/22; G01D 5/14; G06F 1/16

(52) U.S. Cl. CPC G02B 7/023; G01L 1/22; G01D 5/145; G06F 1/163

(57) ABSTRACT

A head-mounted device may have a display with pixel arrays that display content for a user. A head-mounted support structure in the device supports the pixel arrays on the head of the user. A left positioner may be used to position a left lens assembly that includes a left lens and a first pixel array. A right positioner may be used to position a right lens assembly that includes a right lens and a second pixel array. Control circuitry may adjust the positions of the left and right lens assemblies using interpupillary distance information. Sensing circuitry such as force sensing circuitry may be used to ensure that the lens assemblies do not apply excessive force on a nose. Force sensors may be included between the lens assemblies and the nose, such as in, on, or adjacent to a nasal flap, or may be coupled to the lens assemblies.

This application claims the benefit of U.S. provisional patent application No. 63/355,990, filed Jun. 27, 2022, and U.S. provisional patent application No. 63/431,514, filed Dec. 9, 2022, which are hereby incorporated by reference herein in their entireties.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses. The lenses allow displays in the devices to present visual content to users.

Users have faces of different shapes and sizes. This can pose challenges when a head-mounted device is to be used by multiple users. If care is not taken, a head-mounted device may not fit well for certain users.

### SUMMARY

A head-mounted device may have a display that displays content for a user. Head-mounted support structures in the device support the display on the head of the user.

The head-mounted device may have lenses in lens assemblies (also referred to as lens modules herein). A left positioner may be used to position a left lens assembly. A right positioner may be used to position a right lens assembly. The left and right lens modules may have respective left and right lenses and respective left and right portions of a display.

To accommodate users with different interpupillary distances, the left and right lens assemblies may be moved towards or away from each other. A user may supply the interpupillary distance of the user to the head-mounted device, an image sensor or other device may be used in measuring the interpupillary distance to provide to the head-mounted device, and/or gaze tracking sensors in the head-mounted device may measure the interpupillary distance of the user while the head-mounted device is being worn on the head of the user. Other sensing arrangements may be used to measure lens assembly positions relative to the user's nose, if desired.

To avoid excessive pressure on a user's nose, sensing circuitry such as force sensing circuitry may be used to detect the pressure applied to the user's nose by the left and right lens assemblies. Control circuitry may stop the positioners from moving the lens assemblies closer to the user's nose in response to determining that a force threshold has been reached, and may reposition the lens assemblies further from the nose, if desired. In this way, the lens assemblies may be adjusted to match the user's interpupillary distance or to get as close as possible to the user's interpupillary distance without applying too much force to the user's nose.

### BRIEF DESCRIPTION OF THE DRAWINGS

FIG. 1 is a schematic diagram of an illustrative electronic device such as a head-mounted display device in accordance with an embodiment.

FIG. 2 is a top view of an illustrative head-mounted device in accordance with an embodiment.

FIG. 3 is a front view of an illustrative lens assembly having a force or position sensor in accordance with an embodiment.

FIG. 4A is a front view of an illustrative direct force sensor in accordance with an embodiment.

FIG. 4B is a top view of an illustrative sensor woven into a fabric in accordance with an embodiment.

FIG. 4C is a cross-sectional side view of an illustrative nasal flap with an air bladder sensor in accordance with an embodiment.

FIG. 5 is a front view of an illustrative lens assembly having a proximity sensor in accordance with an embodiment.

FIG. 6 is a front view of an illustrative lens assembly having movable components that block a light-emitting component to indicate a position of the lens assembly in accordance with an embodiment.

FIG. 7 is a circuit diagram of an illustrative control circuit for controlling a positioner motor while monitoring for feedback from the motor in accordance with an embodiment.

FIG. 8 is a flow chart of illustrative steps involved operating a head-mounted device in accordance with an embodiment.

FIG. 9 is a front view of an illustrative lens assembly having strain gauges on blades between an optical module, an intermediate structure, and a trim piece in accordance with an embodiment.

FIG. 10 is a front view of an illustrative lens assembly and attachment structure having strain gauges coupled to flexible members of the attachment structure in accordance with an embodiment.

FIGS. 11A-11D are front views of illustrative force sensors that include springs and load cells in accordance with some embodiments.

### DETAILED DESCRIPTION

Electronic devices may include displays and other components for presenting content to users. The electronic devices may be wearable electronic devices. A wearable electronic device such as a head-mounted device may have head-mounted support structures that allow the head-mounted device to be worn on a user's head.

A head-mounted device may contain a display formed from one or more display panels (displays) for displaying visual content to a user. A lens system may be used to allow the user to focus on the display and view the visual content. The lens system may have a left lens that is aligned with a user's left eye and a right lens that is aligned with a user's right eye.

Not all users have eyes that are separated by the same interpupillary distance. To ensure that a wide range of users are able to comfortably view content on the display, the head-mounted device may be provided with lens positioners. The lens positioners may be used in adjusting the lens-to-lens spacing between the left and right lenses to match the interpupillary distance of the user.

To prevent excessive pressure on the surface of the user's nose, force sensors can be used determine how much pressure is applied to the user's nose with the lenses as the lens-to-lens spacing is changed. Control circuitry in the head-mounted device may adjust the left and right lenses to match the user's interpupillary distance, unless the lenses apply too much pressure to the user's nose (e.g., the pressure measured by the force sensors exceeds a threshold). In some situations, the left and right lenses may be spaced so that the lens-to-lens spacing between the left and right lenses matches the user's interpupillary distance. In other situations, the lens-to-lens spacing between the left and right lenses will be slightly larger than the user's interpupillary distance to ensure that the lenses do not press excessively against the user's nose. Sensor circuitry such as force sensing circuitry may be used to provide the control circuitry with real-time feedback on the pressure applied by the lenses to the user's nose, thereby ensuring that the positions of the left and right lenses are adjusted satisfactorily.

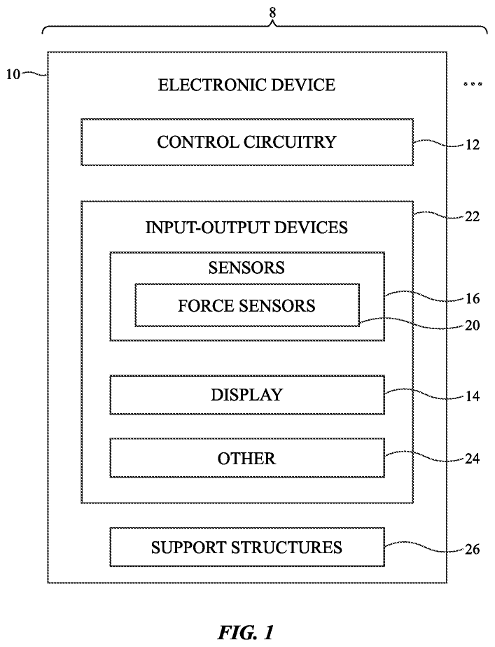

A schematic diagram of an illustrative system having an electronic device with sensor circuitry that ensures satisfactory placement of lenses relative to a user's facial features is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involved in processing three-dimensional facial image data, operations involving the adjustment of components using control signals, etc.). Control circuitry 12 may include wired and wireless communications circuitry. For example, control circuitry 12 may include radio-frequency transceiver circuitry such as cellular telephone transceiver circuitry, wireless local area network (WiFi®) transceiver circuitry, millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video and/or audio data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as display 14. In some configurations, display 14 of device 10 includes left and right display panels (sometimes referred to as left and right portions of display 14 and/or left and right displays) that are in alignment with the user's left and right eyes and are viewable through left and right lens assemblies, respectively. In other configurations, display 14 includes a single display panel that extends across both eyes.

Display 14 may be used to display images. The visual content that is displayed on display 14 may be viewed by a user of device 10. Displays in device 10 such as display 14 may be organic light-emitting diode displays or other displays based on arrays of light-emitting diodes, liquid crystal displays, liquid-crystal-on-silicon displays, projectors or displays based on projecting light beams on a surface directly or indirectly through specialized optics (e.g., digital micromirror devices), electrophoretic displays, plasma displays, electrowetting displays, microLED displays, or any other suitable displays.

Display 14 may present computer-generated content such as virtual reality content and mixed reality content to a user. Virtual reality content may be displayed in the absence of real-world content. Mixed reality content, which may sometimes be referred to as augmented reality content, may include computer-generated images that are overlaid on real-world images. The real-world images may be captured by a camera (e.g., a forward-facing camera) and merged with overlaid computer-generated content or an optical coupling system may be used to allow computer-generated content to be overlaid on top of real-world images. As an example, a pair of mixed reality glasses or other augmented reality head-mounted display may include a display device that provides images to a user through a beam splitter, prism, holographic coupler, or other optical coupler. Configurations in which display 14 is used to display virtual reality content to a user through lenses are described herein as an example.

Input-output devices 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, buttons, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), fingerprint sensors and other biometric sensors, optical position sensors (optical encoders), and/or other position sensors such as linear position sensors, and/or other sensors. As shown in FIG. 1, sensors 16 may include sensing circuitry (sensor circuitry) that is configured to measure the pressure applied between objects in system 8. The sensing circuitry may include one or more sensors such as one or more force sensors 20. Sensing circuitry such as force sensors 20 may, for example, be used to sense an amount of pressure applied by lens assemblies in device 10 to a user's nose.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, and other electrical components. Device 10 may include circuits for receiving wireless power, circuits for transmitting power wirelessly to other devices, batteries and other energy storage devices (e.g., capacitors), joysticks, buttons, and/or other components.

Electronic device 10 may have housing structures (e.g., housing walls, straps, etc.), as shown by illustrative support structures 26 of FIG. 1. In configurations in which electronic device 10 is a head-mounted device (e.g., a pair of glasses, goggles, a helmet, a hat, a headband, etc.), support structures 26 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support display(s) 14, sensors 16, other components 24, other input-output devices 22, and control circuitry 12.

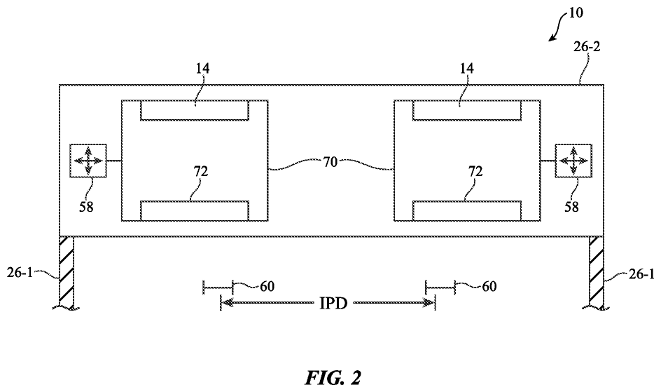

FIG. 2 is a top view of electronic device 10 in an illustrative configuration in which electronic device 10 is a head-mounted device. As shown in FIG. 2, electronic device 10 may include support structures (see, e.g., support structures 26 of FIG. 1) that are used in housing the components of device 10 and mounting device 10 onto a user's head. These support structures may include, for example, structures that form housing walls and other structures for main unit 26-2 (e.g., exterior housing walls, lens assembly structures, etc.) and straps or other supplemental support structures such as structures 26-1 that help to hold main unit 26-2 on a user's face so that the user's eyes are located within eye boxes 60.

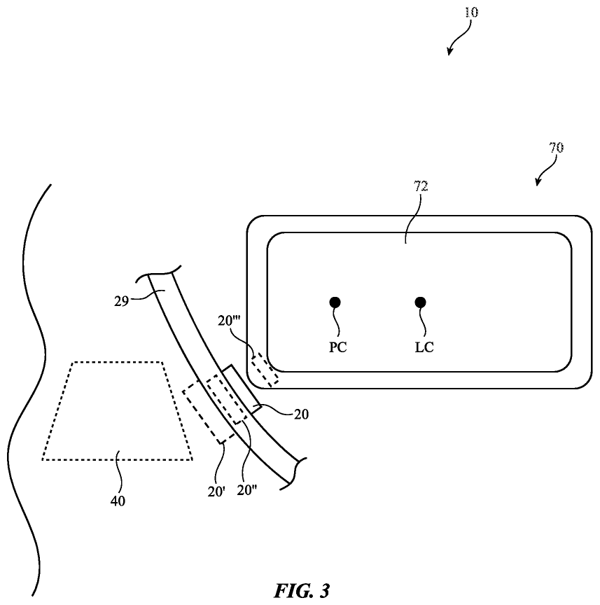

Display 14 may include left and right display panels (e.g., left and right pixel arrays, sometimes referred to as left and right displays or left and right display portions) that are mounted respectively in left and right display modules 70 corresponding respectively to a user's left eye (and left eye box 60) and right eye (and right eye box). Modules 70, which may sometimes be referred to as lens support structures, lens assemblies, lens housings, or lens and display housings, may be individually positioned relative to the housing wall structures of main unit 26-2 and relative to the user's eyes using positioning circuitry such as respective left and right positioners 58. Positioners 58 may include stepper motors, piezoelectric actuators, motors, linear electromagnetic actuators, and/or other electronic components for adjusting lens assembly positions. Positioners 58 may be controlled by control circuitry 12 during operation of device 10. For example, positioners 58 may be used to adjust the spacing between modules 70 (and therefore the lens-to-lens spacing between the left and right lenses of modules 70) to match the interpupillary distance (IPD) of a user's eyes. This allows the user to view the left and right display portions of display 14 in the left and right lens modules. In some cases, however, the lenses may apply excess pressure to the user's nose if adjusted to the user's IPD. Therefore, sensors may be incorporated into device 10 to monitor the pressure on the user's nose. An illustrative arrangement that includes force sensors to monitor the pressure applied to the user's nose is shown in FIG. 3.

As shown in FIG. 3, lens assembly 70 (e.g., one of the two lens modules 70 shown in FIG. 2) may be adjacent to the user's nose 40 when device 10 is being worn on a user's head. Only one of the two lens modules is shown in FIG. 3 for simplicity, but the other lens assembly 70 may have the same structure.

To ensure that display 14 is viewable by the user when the user's eyes are located in eye boxes 60 (FIG. 2), control circuitry 12 may attempt to align lens centers LC with the centers PC of the user's eyes. At the same time, control circuitry 12 may use sensor circuitry such as force sensors 20 to monitor the pressure applied to nose 40 by lens modules 70 to ensure that lens modules 70 do not press excessively on nose 40 and cause discomfort.

In scenarios in which the user's nose is small, there may be ample room available to align lens centers LC with eye centers PC. In scenarios in which the user's nose is larger, control circuitry 12 may position modules 70 as shown in FIG. 3. For example, a distance between lens modules 70 (the lens-to-lens spacing) may be larger than would be desired for perfect alignment of lens centers LC with eye centers PC. The use of this wider lens-to-lens spacing helps ensure that lens modules 70 will not exert more inward force on nose 40 than would be comfortable to a user, while still allowing satisfactory viewing of content on display 14 through lenses 72. Lens modules 70 may be placed at a non-zero distance (gap) from the side surfaces of nose 40 or may be spaced apart from the side surfaces of nose 40 by a predetermined gap. A user may select which of these options is most comfortable to the user and/or a default setting may be supplied to control circuitry 12.

In operation, positioners 58 may move lens modules 70 (FIG. 2) toward nose 40, attempting to align the lens center LC of each lens with eye centers PC. Sensors may be incorporated into device 10 to ensure that excess pressure is not applied to nose 40 by lens modules 70. In general, any desired sensor circuitry may be used to measure the pressure on nose 40. In one example, each lens module 70 may have one or more force sensors 20.

Force sensor 20 may be incorporated between nasal flap 29 and each lens assembly 70. Nasal flap 29 may be a fabric, polymer, or other material component that allows for a comfortable fit for a user of device 10. For example, nasal flap 29 may be interposed between each lens assembly 70 and nose 40. In some embodiments, nasal flap 29 may extend along both sides and over the top of nose 40 (e.g., over at least a portion of a bridge of nose 40). However, this is merely illustrative. Nasal flap 29 may have two separate portion, one between left lens assembly 70 and nose 40 and another between right lens assembly 70 and nose 40, or may be omitted from device 10 if desired.

In embodiments in which nasal flap 29 is included in device 10, force sensors 20 may be incorporated between each lens assembly 70 (i.e., left lens assembly 70 and right lens assembly 70) and nasal flap 29. However, this location of force sensors 20 is merely illustrative. In general, force sensors 20 may be included in any desired location within device 10. For example, force sensors 20 may be formed between nasal flap 29 and nose 40 as shown by position 20′, may be formed within nasal flap 29 or be integral with nasal flap 29 as shown by position 20″, or may be formed within lens assembly 70 as shown by position 20″′.

Although FIG. 3 shows a single force sensor 20 between nose 40 and lens assembly 70, this is merely illustrative. Device 10 may have one force sensor 20 between nose 40 and each lens assembly 70, may have multiple force sensors between nose 40 and each lens assembly 70, may have one single force sensor between nose 40 and one lens assembly 70, or may have any other desired arrangement of force sensor(s) 20.

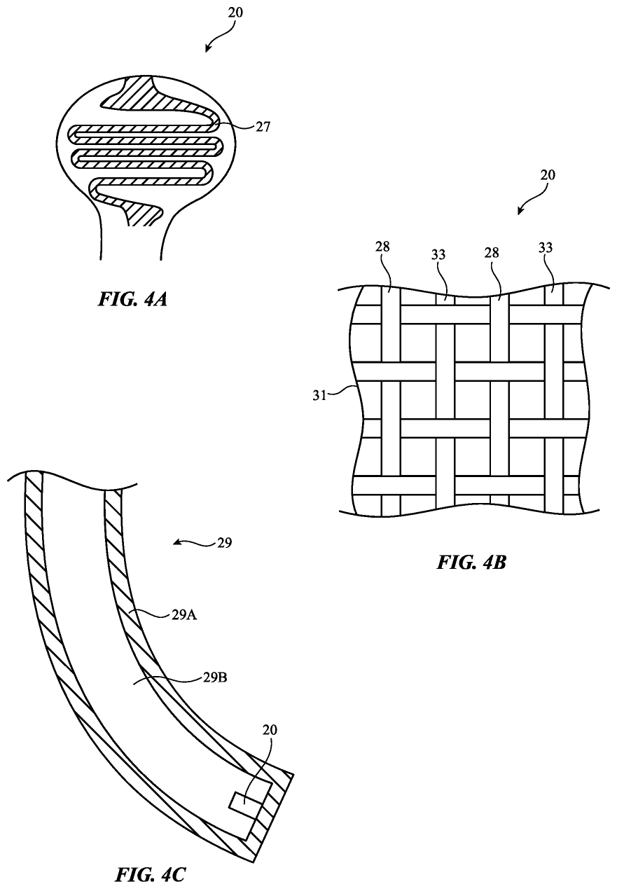

Regardless of where force sensors 20 are formed within device 10, force sensors 20 may monitor the amount of force applied to nose 40 by lens modules 70 to ensure that excess pressure is not applied to nose 40. Force sensors 20 may continuously monitor the applied force, or may flag control circuitry 12 when the applied force surpasses a threshold. Force sensors 20 may be any desired type of sensor that monitors the amount of force/pressure applied to nose 40. Some examples of force sensors 20 are shown in FIGS. 4A-C.

In some examples, force sensor(s) 20 may be direct force sensors, such as force sensor 20 of FIG. 4A. Direct force sensor 20 of FIG. 4A may be a pressure sensitive resistor and may include electrodes formed form interdigitated finger traces 27. In particular, when pressure is applied to direct force sensor 20, the resistance may be determined due to a change in distance between portions of interdigitated finger traces 27, and circuitry, such as control circuitry 12, may determine the force applied to direct force sensor 20. If direct force sensor 20 is placed in any of the possible locations shown in FIG. 3, or otherwise placed between a user's nose and lens assembly 70, direct force sensor 20 may be used to determine the force that lens assembly 70 applies to nose 40 as it is moved toward nose 40. Direct force sensor 20 may be used to continuously measure the pressure against nose 40, or may be used as a thresholding sensor (i.e., control circuitry 12 may determine that the resistance of direct force sensor 20 is over a threshold and that the force on nose 40 is therefore too great).

In other examples, force sensor(s) 20 may be formed from conductive strands, yarn, or fibers and incorporated into a fabric in device 10. For example, force sensor(s) 20 may be formed form smart fabrics or other fabrics that include conductive strands. The conductive strands may be arranged to form a force sensor. An example of this arrangement is shown in FIG. 4B.

As shown in FIG. 4B, force sensor 20 may be incorporated into fabric 31. In particular, fabric 31 may include conductive strands 28 and non-conductive strands 33. Conductive strands 28 may be arranged to form a force sensor or a portion of a force sensor (e.g., an electrode of a sensor that indicates when the sensor is in contact with the user's nose). For example, control circuitry, such as control circuitry 12, may measure capacitance or resistance changes between conductive strands 28. Because the capacitance/resistance will change as the distance between conductive strands 28 changes, the capacitance/resistance measurements are indicative of the amount of force on fabric 31. Conductive strands may be formed from a metal, such as silver or copper, which may optionally be coated onto a polymer or fabric strand.

Although conductive strands 28 are shown as straight strands in FIG. 4B, this is merely illustrative. In some embodiments, conductive strands 28 may be serpentine or have other desired shapes, which may allow fabric 31 to have improved flexibility.

Non-conductive strands 33 may be interspersed between at least some of conductive strands 28, if desired. As shown in FIG. 4B, every other strand may be a non-conductive strand. However, this is merely illustrative. Any desired number of conductive and non-conductive strands may be incorporate into fabric 31 to form force sensor 20.

Fabric 31 may form some or all of nasal flap 29, or may otherwise cover nasal flap 29. Because nasal flap 29 is between nose 40 and lens assembly 70 when device 10 is worn by a user (FIG. 2), force sensor 20 may indicate the amount of force applied to nose 40 by lens assembly 70. Any desired number of force sensors 20 may be incorporated into nasal flap 29 in this way.

Alternatively or additionally, fabric 31 may be otherwise incorporated into device 10. For example, fabric 31 may form a curtain fabric that is incorporated into device 10 between support structure 26-2 and lenses 70 (FIG. 2) to hide internal components. At least a portion of the curtain fabric having force sensor(s) 20 may be between lens assembly 70 and nose 40 (e.g., between lens assembly 70 and nasal flap 29) and may therefore measure the force applied to nose by lens assembly 70. In general, however, fabric 31 may be incorporated into device 10 into any desired manner. Any desired number of force sensors 20 may be incorporated into fabric 31.

In other examples, force sensor(s) 20 may be incorporated into an interior region of nasal flap 29. An example of an arrangement in which a force sensor is located in the interior of nasal flap 29 is shown in FIG. 4C.

As shown in FIG. 4C, nasal flap 29 may have peripheral region 29A that surrounds inner region 29B (also referred to as a cavity herein). Peripheral region 29A may be formed from polymer, rubber, or any other desired material. Inner region 29B may be filled with air, gas, liquid, or any other desired substance. Force sensor 20 may be located in inner region 29B and may produce a force measurement in response to increased pressure in inner region 29B. For example, as lens assembly 70 squeezes nasal flap 29 against nose 40 (FIG. 2), the pressure of the air, gas, liquid, or other material within nasal flap 29 may increase, increasing the pressure on force sensor 20. In some examples, force sensor 20 may be a barometric pressure sensor that measures the increased pressure within inner region 29B when lens assembly 70 is moved against nose 40. Therefore, force sensor 20 may produce a force measurement indicative of the force applied to the user's nose by lens assembly 70.

Although FIG. 4C shows one side or portion of nasal flap 29, this is merely illustrative. Any desired number of force sensors 20 may be incorporated into inner region 29B of nasal flap 29 on one or both sides of the user's nose. Additionally, although FIG. 4C shows force sensor 20 implemented as a pressure sensor in nasal flap 29, force sensor 20 may be a pressure sensor anywhere between nose 40 and lens assembly 70 when worn by a user. For example, force sensor 20 may be implemented as a pressure sensor within an edge portion of lens assembly 70 (i.e., in position 20″′ of FIG. 3), if desired.

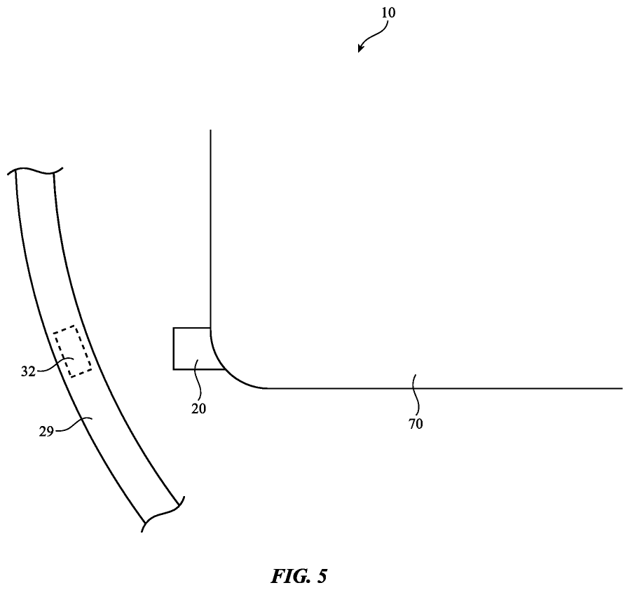

As an alternative to the sensors shown in FIGS. 4A-C, force sensor 20 may be implemented to measure the deflection of nasal flap 29 relative to lens assembly 70. An example of this type of force sensor is shown in FIG. 5.

As shown in FIG. 5, force sensor 20 may be mounted to (or within) a portion of lens assembly 70. Force sensor 20 may be a sensor that measures the proximity of nasal flap 29, such as a capacitive proximity sensor, a resistive proximity sensor, an optical proximity sensor, an ultrasonic proximity sensor, or any other desired type of proximity sensor. Optionally, magnet 32 may be embedded within (or mounted to) nasal flap 29, and force sensor 20 may be implemented as a Hall Effect sensor. In this way, the Hall Effect sensor may determine the proximity of magnet 32 and therefore the proximity of nasal flap 29. By measuring the proximity of nasal flap 29 (i.e., the amount by which nasal flap 29 has moved), the proximity sensor may provide an output that is indicative of the amount of force applied to the user's nose by lens assembly 70.

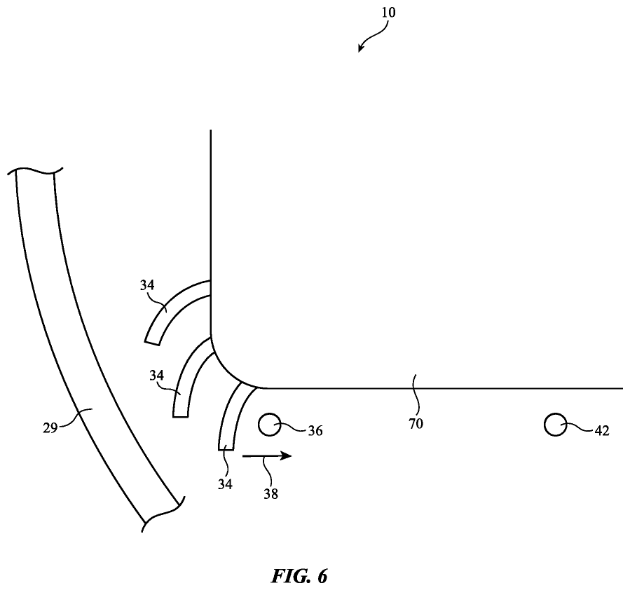

Although the previous embodiments have included a dedicated force sensor 20 to ensure that excessive force is not applied to a user's nose, this is merely illustrative. Device 10 may use other sensors (such as sensors 16) to determine if the force applied to nose 40 exceeds a threshold. An example of this arrangement is shown in FIG. 6.

As shown in FIG. 6, one or more flexible members 34 may extend from lens assembly 70. Flexible members 34 may be formed from rubber, polymer, fabric, or any other desired flexible material. Device 10 may also include light-emitting component 36 and light-detecting component 42, which may be used in gaze tracking or other desired operations. For example, light-emitting component 36 may be an infrared light-emitting component and light-detecting component 42 may be an infrared light-detecting component. To determine the gaze of a user of device 10, infrared light-emitting component 36 may emit light toward the eye of the user, and the reflections from the user's eye may be detected by infrared light-detecting component 42. These reflections may indicate the direction of the user's gaze. In general, however, light-emitting component 36 and light-detecting component 42 may be any desired components and may operate in any desired wavelength.

When assembly 70 moves toward nasal flap 29 (and therefore nose 40), it will eventually contact and push against nasal flap 29 and nose 40, causing flexible members 34 to be moved in direction 38. If flexible members 34 move far enough (i.e., the amount of force applied to nose 40 exceeds or meets a threshold), flexible members 34 may block light-emitting component 36. As a result, light-detecting component 42 may stop detecting light emitted by light-emitting component 36. Based on the changed signal of light-detecting component 42, control circuitry 12 may stop positioners 58 from moving lens assembly 70 further toward the user's nose.

Although flexible members 34 are shown as covering light-emitting component 36, this is merely illustrative. Flexible members 34 may cover light-detecting component 42, or may merely move between light-emitting component 36 and light-detecting component 42. Additionally, any desired number of flexible members 34 may be used.

In some embodiments, light-detecting component 42 may be used without intervening flexible members 34 to determine the position of the user's nose. For example, light-detecting component 42 may be a camera (e.g., a camera sensitive to visible light) that determines how close lens assembly 70 is to nose 40. Control circuitry, such as control circuitry 12 (FIG. 1), may process images or video captured by camera 42 to determine the position of lens assembly 70 relative to nose 40. If lens assembly 70 is within a threshold distance of nose 40 or has depressed nose 40 by a threshold amount, then control circuitry 12 may stop positioners 58 from moving lens assembly 70 closer to nose 40.

Alternatively or additionally, a three-dimensional scan may be performed on a user of device 10 to ensure a proper fitting. The three-dimensional scan may be performed by three-dimensional sensors (such as cameras, infrared dot projectors, infrared sensors, etc.) in device 10 or external to device 10. The three-dimensional scan may be used to capture the topology of a user's face. Control circuitry 12 may then use the topology of the user's face to ensure that positioners 58 do not move lens assemblies 70 too close into nose 40 or apply too much force onto nose 40. For example, control circuity 12 may use the topology information to calculate a maximum distance that lens assemblies can move without applying too much force to nose 40 and limit movement to that maximum distance.

Alternatively or additionally, device 10 may include a manual button that a user may press to indicate discomfort from too much force on nose 40. In response to detecting a press of the manual button, positioners 58 may stop moving lens assemblies 70 toward nose 40. If desired, positioners 58 may also reverse to back lens assemblies 70 off of nose 40 in response to the press of the manual button and/or excessive force detection. For example, positioners 58 may move lens modules 70 off of nose 40 by a desired gap (e.g., a gap G of at least 0.1 mm, at least 0.2 mm, at least 1 mm, at least 2 mm, less than 5 mm, or other suitable spacing).

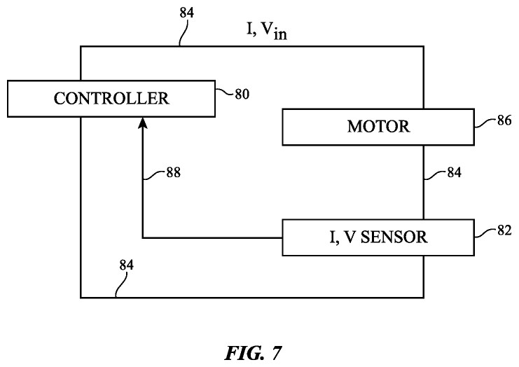

If desired, the position of lens modules 70 relative to the corresponding surfaces of nose may be measured using feedback from motors in positioners 58 as lens modules 70 are moved into contact with the surfaces of nose 40. An illustrative control circuit for a positioner such as positioner 58 is shown in FIG. 7. Control circuitry 12 (FIG. 1) may include a motor controller such as controller 80. Controller 80 may drive motor 86 in a positioner 58 to move an associated lens module 70 by suppling a power supply voltage Vin to motor 86 using path 84. While voltage Vin is being supplied to motor 86, controller 80 of control circuitry 12 monitors the resulting current flow (current I) through path 84 using sensor circuit 82 (e.g., a current sensing resistor with a corresponding analog-to-digital converter circuit, etc.). Power supply voltage Vin may remain relatively constant while motor 86 moves lens assembly 70. Positioner 58 may initially be used to position an edge of lens assembly 70 at a location that is distant from nose 40. Control circuitry 12 may then direct positioner 58 to move lens assembly 70 toward nose 40. Controller 80 of control circuitry 12 may monitor the current I that flows through path 84 and I sensed by sensor 82. When lens assembly 70 is pressed against the side of nose 40, current I will increase. When current I surpasses a desired threshold (that is related to the force applied to nose 40), control circuitry 12 may stop positioner 58 from applying more force to nose 40 with lens assembly 70.

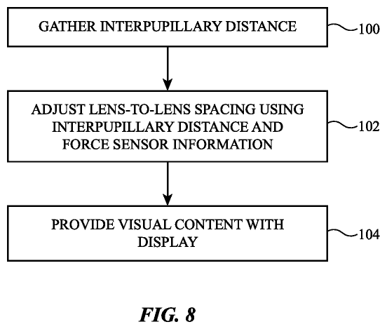

Illustrative operations involved in operating device 10 in system 8 are shown in FIG. 8.

During the operations of block 100, information on the distance between the user's eyes (interpupillary distance IPD, sometimes referred to as pupillary distance) may be gathered. With one illustrative arrangement, device 10 or other equipment in system 8 gathers the user's interpupillary distance from the user by prompting the user to type the interpupillary distance into a data entry box on display 14 or a display in other equipment in system 8. The user may also supply the user's interpupillary distance using voice input or other user input arrangements. With another illustrative arrangement, a sensor in device 10 or other a sensor in a stand-alone computer, portable device, or other equipment in system 8 may measure the user's interpupillary distance. For example, a sensor such as a two-dimensional or three-dimensional image sensor may gather an image of the user's face to measure the value of interpupillary distance IPD. After the measurement of the interpupillary distance has been made, the interpupillary distance may be provided to device 10 (e.g., over a wired or wireless communications paths). If desired, gaze trackers may measure the locations of the centers of the user's eyes PD and thereby determine IPD from direct measurement as a user is wearing device 10 on the user's head.

After gathering interpupillary distance IPD, control circuitry 12 of device 10 may, during the operations of block 102, use positioners 58 to adjust the lens-to-lens spacing between lens centers LC so that this distance matches interpupillary distance IPD and so that the centers of lenses 72 are aligned with respective eye centers PC. While positioners 58 are moving lens modules 70 and lenses 72 (e.g., while the lens-to-lens spacing is being reduced to move modules 70 towards adjacent surfaces of the user's nose), control circuitry 12 uses force sensing circuitry (e.g., force sensor(s) 20) to monitor the force applied by lens modules 70 on nose 40). In some situations, the user's nose 40 may prevent lenses 72 from being brought sufficiently close to each other to allow the lens-to-lens spacing to exactly match IPD without creating a risk of discomfort for the user.

In other words, force sensor(s) 20 may indicate that too much force is being applied to nose 40 by lens modules 70, or that the force being applied to nose 40 by lens modules 70 has reached a threshold. Alternatively or additionally, device 10 may include a manual button that a user may press to indicate discomfort from too much force on nose 40. In response to the excessive force measured by force sensor(s) 20 or the press of the button by a user, control circuitry 12 may then stop positioners 58 from moving lens modules 70 further toward nose 40. If desired, positioners 58 may move lens modules 70 off of nose 40 by a desired gap (e.g., a gap G of at least 0.1 mm, at least 0.2 mm, at least 1 mm, at least 2 mm, less than 5 mm, or other suitable spacing).

Following the positioning of modules 70 at desired locations relative to nose 40 to ensure user comfort while wearing device 10, control circuitry 12 may use display 14 to present visual content to the user through lenses 72 (block 104).

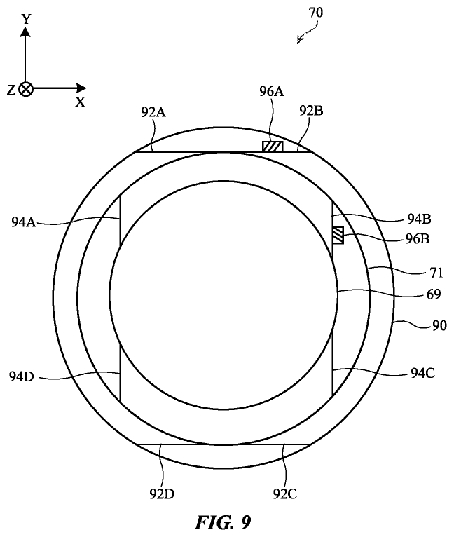

Instead of, or in addition to, mounting force sensors on the nasal flap, force sensors may be coupled to the lens modules. An illustrative example of force sensors coupled to a lens module is shown in FIG. 9.

As shown in FIG. 9, lens module 70 may include optical module 69 (also referred to as an optical portion herein) surrounded by trim ring 90. Trim ring 90 may be a metal, plastic, or other material trim ring that surrounds optical module 69. Additionally, lens module 70 may have may have intermediate trim piece 71 between optical portion 69 and trim ring 90. To mount force sensors to lens module 70, blades 92A-D may be mounted between intermediate trim piece 71 and trim ring 90, while blades 94A-D may be mounted between optical portion 69 and intermediate trim piece 71. In particular, flexible structures 92 and 94 (also referred to as flexible structures and blade structures herein) may be formed from metal, plastic, other polymer, or other desired material. In an illustrative example, flexible structures 92 and 94 may be formed from sheets of flexible metal, such as steel or other metal with a low thickness, such as less than 300 microns, less than 260 microns, less than 250 microns, or other suitable thickness

Blades 92 may extend in the x-direction between intermediate trim piece 71 and trim ring 90. Blades 94 may extend in the y-direction between optical portion 69 and intermediate trim piece 71. To measure the force applied to lens module 70, such as when lens module 70 contacts the user's nose when making adjustments based on IPD, strain gauges 96A and 96B may be coupled to blades 92 and 94. In the example of FIG. 9, strain gauge 96A is coupled to blade 92B, and strain gauge 96B is coupled to blade 94B. However, this arrangement is merely illustrative. In general, strain gauges 96 may be coupled to any of flexible structures 92 and 94. Moreover, more than two strain gauges 96 may be used, if desired. In some embodiments, all of flexible structures 92 and 94 may have an associated strain gauge 96. Alternatively, only one of flexible structures 92 or 94 may have a strain gauge 96, if desired.

When lens module 70 contacts the user's nose, trim ring 90 and/or intermediate trim piece 71 may deflect, causing deflections of blades 92 and/or blades 94. Strain gauges 96 may measure these deflections, which may be proportional to the force applied to the nose. In this way, strain gauges 96 may monitor the force applied to the nose by lens module 70. If the force is too great, control circuitry, such as control circuitry 12, may stop the lens modules from moving toward the user's nose, and may reverse away from the user's nose by a set distance, if desired. In this way, strain gauges on blades 92 and/or 94 may monitor the force applied to a user's nose to avoid excessive pressure on the nose.

Although FIG. 9 shows flexible structures 92 between intermediate trim piece 71 and trim ring 90, and flexible structures 94 between optical portion 69 and intermediate trim piece 71, this is merely illustrative. Blades 92 may extend between intermediate trim piece 71 and optical portion 69, and blades 94 may extend between intermediate trim piece 71 and trim ring 90, if desired. Regardless of the arrangement of blades 92 and 94, strain gauges 96 may be coupled to the blades to detect whether lens module 70 is applying excessive pressure to a nose.

Although FIG. 9 shows blades 92 and 94 extending in the x and y directions, this is merely illustrative. In general, blades 92 and 94 may extend in any desired directions, including the z-direction or intermediate directions between the x, y, and/or z directions. Moreover, although FIG. 9 shows blades 92 and 94 between optical portion 69, intermediate trim piece 71, and trim ring 90, this is merely illustrative. In some embodiments, intermediate trim piece 71 may be omitted, and blades 92 and 94 may extend directly between optical portion 69 and trim ring 90.

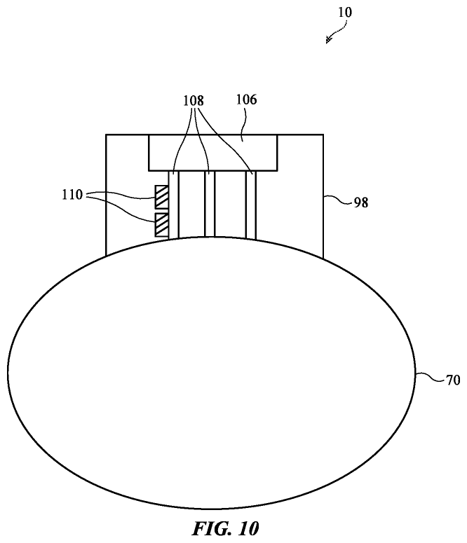

Instead of, or in addition to, having strain gauges within lens module 70, strain gauges may be coupled to an attachment mechanism between lens module 70 and head-mounted housing 26. An illustrative example of this arrangement is shown in FIG. 10.

As shown in FIG. 10, device 10 may include attachment structure 98 (also referred to as coupler 98 herein), which may couple lens module 70 to a head-mounted housing, such as housing 26 of FIG. 2. Coupler 98 may be attached to housing 26 with attachment 106. In some embodiments, attachment 106 may include a pin, rod, or other mechanism that allows lens module 70 to slidably move with respect to head-mounted housing 26. In general, however, attachment 106 may include any desired component to attach lens module 70 to housing 26.

Coupler 98 may also include flexible structures 108 (also referred to as blades 108 herein) that extend between optical module 70 and attachment 106. Flexible structures 108 may be formed from metal, plastic, or other material that flexes when force is applied to lens module 70 (e.g., because attachment 106 remains fixed). For example, blades 108 may be formed from steel or other metal with a low thickness, such as less than 300 microns, less than 260 microns, less than 250 microns, or other suitable thickness.

Strain gauges 110 may be mounted on at least one of blades 108. Strain gauges 110 may measure the strain of blades 108 when force is applied to lens module 70, which is proportional to the force on lens module 70. In this way, the force applied on a nose by lens module 70 may be monitored, and lens module 70 may be stopped from pressing against the nose if there is excessive force applied.

Although strain gauges 110 are shown on only one of blades 108, this is merely illustrative. In general, strain gauges 110 may be applied to any or all of blades 108.

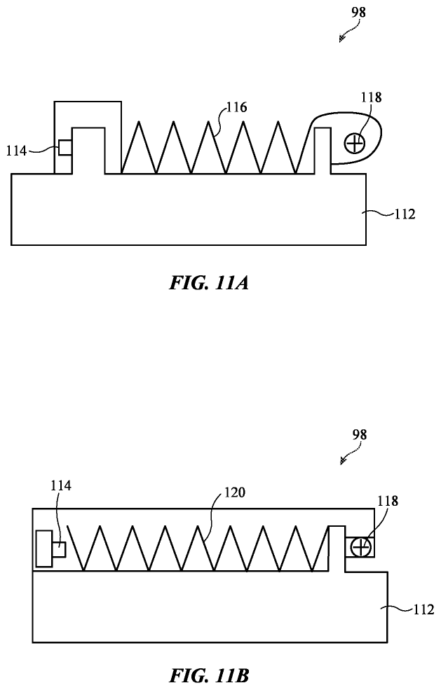

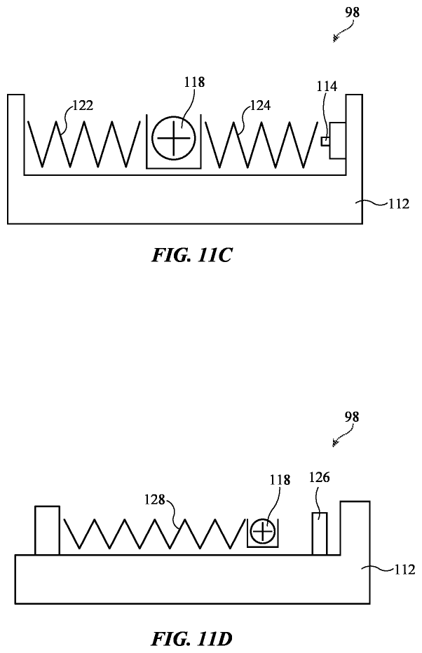

Instead of having strain gauges 110 mounted on blades 108 in coupler 98, coupler 98 may include spring structures and load cells or position sensors to determine how much force is being applied to a nose by module 70. Illustrative arrangements of springs and force sensing components are shown in FIGS. 11A-11D.

As shown in FIG. 11A, coupler 98 may include structure 112, which may be coupled to a top of module 70, and tension spring 116 coupled to structure 112. In particular, tension spring 116 may extend from component 118, which may correspond to attachment 106 of FIG. 10 (e.g., the attachment between coupler 98 and the head-mounted housing), to load cell 114. Load cell 114 may monitor the force applied by spring 114. Because spring 116 is coupled to component 118 and/or structure 112, which are coupled to the optical module, the load cell 114 may be triggered when a force over a desired threshold (determined by the spring 114) is applied to the nose. In particular, the force is proportional to the force applied by module 70 on a nose. In this way, the output of load cell 114 may be monitored, and module 70 may be stopped from applying additional pressure to the nose if excessive force is detected (e.g., when load cell 114 is triggered).

Instead of using a tension spring as in FIG. 11A, compression spring 120 may be used (FIG. 11B) or double spring having segments 122 and 124 may be used (FIG. 11C). Regardless of the type of spring used, the output of load cell 114 may be monitored, and module 70 may be stopped from applying additional pressure to the nose if excessive force is detected.

As another example, a spring interferometer may be used, as shown in FIG. 11D. As shown in FIG. 11D, coupler 98 may include spring 128 coupled to component 118. Interferometer 126 may measure the force applied to the nose by module 70 by monitoring the position of component 118.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. A head-mounted device, comprising:
a display having first and second display portions;
control circuitry configured to supply content using the display;
first and second lens assemblies, wherein the first lens assembly includes the first display portion, and the second lens assembly includes the second display portion;
positioning circuitry configured to adjust a lens-to-lens spacing between the first and second lens assemblies; and
sensor circuitry configured to gather force sensor information in response to the first and second lens assemblies applying a force to a nose.

2. The head-mounted device defined in claim 1, further comprising:
a nasal flap configured to separate the first and second lens assemblies from the nose.

3. The head-mounted device defined in claim 2, wherein the sensor circuitry comprises a first sensor interposed between the nasal flap and the first lens assembly and a second sensor interposed between the nasal flap and the second lens assembly.

4. The head-mounted device defined in claim 3, wherein the first and second sensors are direct force sensors.

5. The head-mounted device defined in claim 4, wherein the direct force sensors comprise resistors having interdigitated finger traces.

6. The head-mounted device defined in claim 3, wherein the first and second sensors are proximity sensors that are configured to measure a proximity of the nasal flap to the first and second lens assemblies.

7. The head-mounted device defined in claim 3, further comprising:
magnets in the nasal flap, wherein the first and second sensors are Hall Effect sensors that are configured to measure a proximity of the magnets.

8. The head-mounted device defined in claim 2, wherein the sensor circuitry comprises a camera configured to capture an image, and the control circuitry is configured to determine a location of the first and second lens assemblies relative to the nose based on the image.

9. The head-mounted device defined in claim 8, wherein the positioning circuitry is configured to stop moving the first and second lens assemblies toward the nose in response to the control circuitry determining that the distance between the first and second lens assemblies and the nose is less than a threshold.

10. The head-mounted device defined in claim 2, wherein the control circuitry is configured to determine a maximum distance that the first and second lens assemblies can be moved toward the nose based on a three-dimensional facial scan, and the positioning circuitry is configured to stop moving the first and second lens assemblies toward the nose after moving the maximum distance.

11. The head-mounted device defined in claim 2, wherein the nasal flap comprises material that surrounds a cavity, and the sensor circuitry comprises a pressure sensor within the cavity.

12. The head-mounted device defined in claim 11, wherein the pressure sensor is a barometric pressure sensor.

13. The head-mounted device defined in claim 1, wherein the sensor circuitry comprises a light-emitting component and a light-detecting component, and the system further comprises:
flexible members that extend from the first and second lens assemblies, wherein the flexible members are configured to move between the light-emitting component and the light-detecting component when the force exceeds a threshold.

14. The head-mounted device defined in claim 1, wherein the positioning circuitry comprises a motor, and the sensor circuitry comprises a sensor that measures a voltage and a current of the motor to determine the force.

15. The head-mounted device defined in claim 1, wherein the positioning circuitry is configured to move the first and second lens assemblies toward the nose and is configured to stop moving the first and second lens assemblies toward the nose in response to the force exceeding a threshold.

16. The head-mounted device defined in claim 15, wherein the positioning circuitry is further configured to move the first and second lens assemblies away from the nose by a gap in response to the force exceeding the threshold.

17. The head-mounted device defined in claim 1, wherein the sensor circuitry is coupled to the first and second lens assemblies and configured to gather nose contact force information.

18. The head-mounted device defined in claim 17, further comprising:
flexible structures coupled to the first lens assembly, wherein the sensor circuitry comprises strain gauges coupled to the flexible structures.

19. The head-mounted device defined in claim 18, wherein the lens-to-lens spacing is configured to be adjusted in a first direction and the flexible structures extend in a second direction that is perpendicular to the first direction.

20. The head-mounted device defined in claim 19, wherein the flexible structures are first flexible structures and the strain gauges are first strain gauges, the head-mounted device further comprising:
second flexible structures that extend in the first direction, wherein the sensor circuitry further comprises second strain gauges coupled to the second flexible structures.

21. The head-mounted device defined in claim 20, wherein the first and second lens assemblies respectively comprise first and second trim pieces, wherein the first and second flexible structures extend from an optical portion of the first lens assembly to the first trim piece.

22. The head-mounted device defined in claim 20, further comprising:
third flexible structures that extend in a third direction that is different from the first and second directions, wherein the sensor circuitry further comprises third strain gauges coupled to the third flexible structures.

23. The head-mounted device defined in claim 17, further comprising:
a head-mounted housing; and
first and second couplers that respectively attach the first and second lens assemblies to the head-mounted housing, wherein the sensor circuitry is coupled to the first and second couplers.

24. The head-mounted device defined in claim 23, further comprising:
flexible structures coupled to the first and second couplers, wherein the sensor circuitry comprises strain gauges coupled to the flexible structures.

25. The head-mounted device defined in claim 24, wherein the lens-to-lens spacing is configured to be adjusted in a first direction and the flexible structures extend in a second direction that is perpendicular to the first direction.

26. The head-mounted device defined in claim 23, further comprising:
springs coupled to the first and second couplers; and
load cells coupled to the springs, wherein the load cells are configured to measure the force.

27. The head-mounted device defined in claim 26, wherein the springs are tension springs.

28. The head-mounted device defined in claim 26, wherein the springs are compression springs.

29. The head-mounted device defined in claim 26, wherein the springs comprise double springs coupled to each of the first and second couplers.

30. The head-mounted device defined in claim 23, further comprising:
springs coupled to the first and second couplers; and
sensors coupled to the first and second couplers, wherein the sensors are configured to determine a distance between the sensors and the springs to determine the force.

31. A head-mounted device, comprising:
first and second pixel arrays configured to display content;
left and right positioners;
left and right lens assembly that are positioned respectively by the left and right positioners, wherein the left lens assembly includes a left lens and the first pixel array and wherein the right lens assembly includes a right lens and the second pixel array;
a nasal flap configured to separate a nose from the left and right lens assemblies;
a left force sensor adjacent to the left lens assembly;
a right force sensor adjacent to the right lens assembly; and
control circuitry configured to position the left and right lens assemblies using the left and right positioners based on information from the left and right force sensors.

32. The head-mounted device defined in claim 31, wherein the left and right force sensors are interposed between the nasal flap and the left and right lens assemblies, respectively.

33. The head-mounted device defined in claim 31, wherein the left and right force sensors are integrated into the nasal flap.

34. The head-mounted device defined in claim 31, wherein the left and right force sensors are interposed between the nasal flap and the nose.

35. A head-mounted device, comprising:
a display;
a lens assembly that includes a portion of the display, wherein the lens assembly includes an optical portion and a trim ring that extends around the optical portion;
a plurality of blades coupled to the optical portion and to the trim ring;
positioning circuitry configured to move the lens assembly; and
strain gauges on the plurality of blades, wherein the strain gauges are configured to gather force sensor measurements.

36. The head-mounted device defined in claim 35, wherein the lens assembly further comprises:
an intermediate trim piece between the optical portion and the trim ring, wherein first blades of the plurality of blades are coupled to the optical portion and the intermediate trim piece and second blades of the plurality of blades are coupled to the intermediate trim piece and the trim ring.

37. The head-mounted device defined in claim 36, wherein first blades of the plurality of blades extend in a first direction, second blades of the plurality of blades extend in a second direction that is perpendicular to the first direction, at least one of the strain gauges is on one of the first blades, and at least another one of the strain gauges is on one of the second blades.

38. The head-mounted device defined in claim 35, wherein each of blades of the plurality of blades is coupled to an associated one of the strain gauges.
